(19) United States
(12) Patent Application Publication
(10) Pub. No.: US 2005/0105243 A1
(43) Pub. Date: May 19, 2005

(54) Electrostatic chuck for supporting a substrate

(75) Inventors: Tae-Won Lee, Incheon-si (KR); Jeong-Min Choi, Seoul (KR); Do-In Bae, Changwon-si (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD

(21) Appl. No.: 10/990,579

(22) Filed: Nov. 17, 2004

(30) Foreign Application Priority Data
Nov. 17, 2003 (KR) 2003-80901

(51) Int. Cl. H02H 1/00

(52) U.S. Cl. 361/234

(57) ABSTRACT

An electrostatic chuck to minimize an arc and a glow discharge during processing of a semiconductor substrate is provided, In one aspect, an electrostatic chuckin a processing chamber includes a body having a first hole for providing a cooling gas to a backside of a substrate to control a temperature of the substrate, an inner electrode for generating an electrostatic force and a dielectric layer. A ceramic block is tightly inserted into a first hole and has a second hole connected to the first hole. A third hole formed through the dielectric layer is connected to the first hole and the second hole. The cooling gas is provided to the backside of the substrate through the first hole or the second hole. Since the first hole is covered with the ceramic block, the generation of an arc or a glow discharge inside the first hole may be minimized, thereby preventing damage to the electrostatic chuck and improving production yields.

### CROSS REFERENCE TO RELATED APPLICATION

This application claims priority to Korean Patent Application No. 2003-80901, filed on Nov. 17, 2003, which is incorporated herein by reference in its entirety.

### BACKGROUND OF THE INVENTION

1. Field of the Invention

The present invention relates, generally, to an electrostatic chuck. More particularly, the present invention relates to an electrostatic chuck that minimizes the generation of an arc and/or a glow discharge during processing of a semiconductor substrate disposed in a processing chamber.

2. Description of the Related Art

Generally, semiconductor devices are manufactured through a fabricating process for forming an electrical circuit on a substrate such as a silicon wafer, an electrical die sorting (EDS) process for testing electrical characteristics of the semiconductor device after the fabricating process and a package process for packaging the semiconductor devices using an epoxy resin after separating the wafer into individual chips.

The fabricating process includes a depositing process for forming a layer on a wafer, a chemical mechanical polishing process for planarizing a surface of the layer, a photolithography process for forming a photoresist pattern on the layer, an etching process for forming a pattern having electrical characteristics in the surface of the layer using the photoresist pattern as a mask pattern, an implantation process for implanting ions into designated areas of the wafer, a cleaning process for removing particles from the wafer, a drying process for drying the wafer after the cleaning process and a testing process for detecting defects of the layer or the pattern.

A conventional processing apparatus uses plasma for forming a layer or etching a layer. The processing apparatus using the plasma includes a processing chamber for processing a substrate, an electrostatic chuck disposed in the chamber for supporting the substrate thereon and an upper electrode for generating the plasma using a reaction gas introduced into the chamber.

The electrostatic chuck uses an electrostatic force for fixing the semiconductor substrate thereon, and the processing apparatus uses the plasma gas for processing the semiconductor substrate. RF power is applied to the upper electrode to generate the plasma gas using a reaction gas. Bias power is applied to the electrostatic chuck to control DC bias and bombarding ion energy . Alternatively, the RF power for generating the plasma may be applied to the electrostatic chuck.

The electrostatic chuck includes a body including aluminum (Al), an insulation layer formed on an upper face of the body, an inner electrode formed on the insulation layer and a dielectric layer formed on the inner electrode. A power supply is connected to the inner electrode. The semiconductor substrate is fixed on the dielectric layer by the electrostatic force. Using the plasma gas, the semiconductor substrate fixed on the electrostatic chuck by the electrostatic force is thermally treated, and a cooling gas is provided to a backside of the semiconductor substrate to control a temperature of the substrate. A helium (He) gas is widely used as the cooling gas. The cooling gas is provided to the backside of the semiconductor substrate through a main hole, a plurality of inner channels and a plurality of holes. The main hole is upwardly extended from a lower face of the electrostatic chuck. The inner channels are formed radiating from an upper end portion of the main hole to positions located at predetermined distances from and along an outer peripheral portion of the electrostatic chuck. The holes are upwardly extended from the inner channels toward an upper face of the electrostatic chuck.

An insulation layer is formed on an inner face of the holes, for example, using an anodizing process. The insulation layer formed on the inner face of the holes has a thickness that is thinner than that of an insulation layer formed on an upper face of the body. A diameter of the holes is about 0.1 mm to about 1 mm. RF power or bias power applied to the body of the electrostatic chuck may cause damage to the insulation layer formed on the inner face of the holes.

As a result, an arc or a glow discharge may be generated inside the holes, thereby causing damage to the body.

### SUMMARY OF THE INVENTION

In general, exemplary embodiments of the present invention provide an electrostatic chuck for minimizing the generation of an arc or a glow discharge during processing of a semiconductor substrate to prevent damage to a body of the electrostatic chuck.

According to an exemplary embodiment of the present invention, an electrostatic chuck includes a body, a block and a dielectric layer. The body has a first hole for providing a cooling gas to a backside of a substrate to control a temperature of the substrate. The block including ceramic is disposed at an upper portion of the first hole and has a second hole connected to the first hole. The dielectric layer fixing the substrate thereon is disposed on upper faces of the body and the block. The dielectric layer includes a third hole connected to the first hole and the second hole.

According to another exemplary embodiment of the present invention, an electrostatic chuck includes a body, a block and a dielectric layer. The body has a first hole for providing a cooling gas to a backside of a substrate to control a temperature of the substrate. The block including porous ceramic is inserted into the first hole. The dielectric layer fixing the substrate thereon is disposed on upper faces of the body and the block. The dielectric layer includes a second hole having a central axis that is substantially identical to that of the first hole.

According to still another exemplary embodiment of the present invention, an electrostatic chuck includes a body, a first block, a second block and a dielectric layer. The body has a first hole for providing a cooling gas to a backside of a substrate to control a temperature of the substrate. The first block having a second hole connected to the first hole is inserted into the first hole. The second block including ceramic is inserted into the second hole and has a third hole connected to the second hole. The dielectric layer fixing the substrate thereon is disposed on upper faces of the first block and the second block. The dielectric layer has a fourth hole connected to the first, second and third holes.

According to the present invention, an inner side face of a first hole is covered with a ceramic block, for example, porous ceramic block. As a result, the generation of an arc or a glow discharge inside the first hole may be minimized, thereby increasing the lifetime of an electrostatic chuck. In addition, particles caused by the arc or the glow discharge are reduced so that production yields of the semiconductor devices may be improved.

These and other exemplary embodiments, features, aspects, and advantages of the present invention will be described and become more apparent from the following detailed description of exemplary embodiments when read in conjunction with accompanying drawings.

### BRIEF DESCRIPTION OF THE DRAWINGS

FIG. 1 is a schematic cross-sectional view showing an electrostatic chuck according to an exemplary embodiment of the present invention.

FIG. 2 is an enlarged cross-sectional view of a portion “A” shown in FIG. 1.

FIG. 3 is a schematic cross-sectional view showing a processing apparatus using plasma having the electrostatic chuck shown in FIG. 1.

FIG. 4 is an enlarged cross-sectional view showing a ceramic block of an electrostatic chuck according to another exemplary embodiment of the present invention.

FIG. 5 is an enlarged cross-sectional view showing a ceramic block of an electrostatic chuck according to still another exemplary embodiment of the present invention.

FIG. 6 is an enlarged cross-sectional view showing an electrostatic chuck according to yet another exemplary embodiment of the present invention.

FIG. 7 is an enlarged cross-sectional view showing an electrostatic chuck according to still yet another exemplary embodiment of the present invention.

### DETAILED DESCRIPTION OF EXEMPLARY EMBODIMENTS

The present invention now will be described more fully hereinafter with reference to the accompanying drawings, in which exemplary embodiments of the present invention are shown. This invention may, however, be embodied in many different forms and should not be construed as limited to the exemplary embodiments set forth herein, but it should be recognized that these exemplary embodiments are provided so that this disclosure will be thorough and complete, and will fully convey the scope of the invention to those skilled in the art. It should be understood that as used herein, when an element such as a layer, region or substrate is described as being “on” or deposited “onto” another element, such language does not preclude the presence of one or more intervening elements.

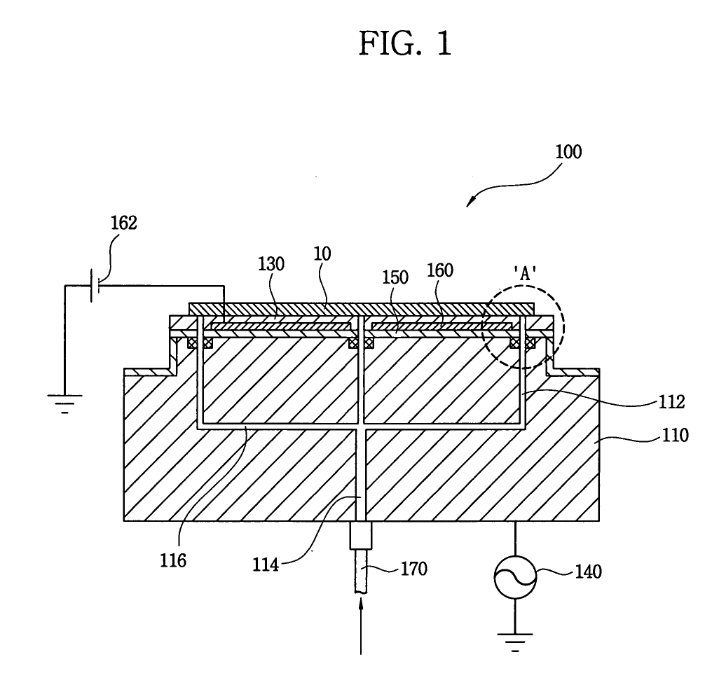

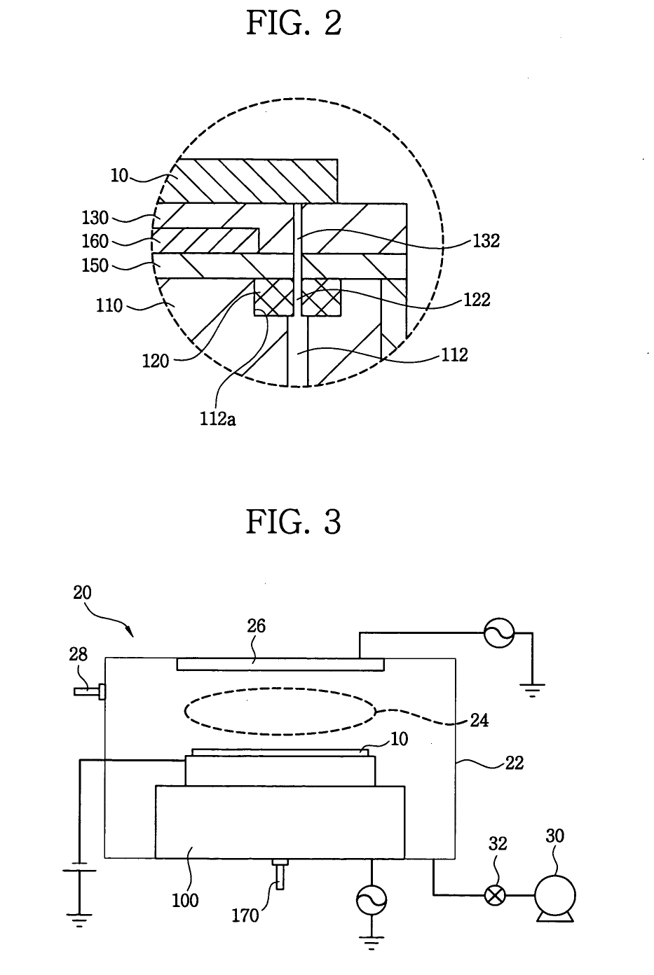

FIG. 1 is a schematic cross-sectional view showing an electrostatic chuck according to an exemplary embodiment of the present invention. FIG. 2 is an enlarged cross-sectional view of the portion “A” shown in FIG. 1.

Referring to FIGS. 1 and 2, the electrostatic chuck 100 includes a body 110, a plurality of blocks 120 and a dielectric layer 130. The body 110 including aluminum (Al) has a plurality of first holes 112 for providing a cooling gas to a backside of a substrate 10. Each of the plurality of blocks 120 including ceramic is disposed at an upper end portion of a corresponding one of the plurality of first holes 112. Each of the blocks 120 has a second hole 122 connected to its corresponding first hole 112. The dielectric layer 130 is disposed on upper faces of the body 110 and the block 120 to fix the substrate 10 thereon.

The body 110 has a round block shape. The body 110 is connected to a RF power supply 140 for generating plasma using a reaction gas. A first insulation layer 150 is formed on an upper face and an outer-side face of the body 110. The first insulation layer 150 includes aluminum oxide and a ceramic plate. The aluminum oxide may be formed, for example, using an anodizing process. The ceramic plate may be formed, for example, using a sintering process. A second insulation layer (not shown) is formed on an inner face of the first hole 112.

An inner electrode 160 connected to DC power supply 162 is disposed on the first insulation layer 150. When power is applied to the inner electrode 160, electrostatic force is generated. As a result, the substrate 10 may be tightly fixed on the dielectric layer 130 by the electrostatic force.

The dielectric layer 130 is formed on upper faces of the inner electrode 160 and the first insulation layer 150. The dielectric layer 130 includes a ceramic plate formed using a sintering process. A plurality of third holes 132 is formed vertically through the first insulation layer 150 and the dielectric layer 130. The third hole 132 is connected to the first hole 112 and the second hole 122.

Preferably, a diameter of the second hole 122 is about 0.1 mm to about 1mm. It is preferable that a diameter of the third hole 132 is substantially equal to that of the second hole 122. It is also preferable that a diameter of the first hole 112 is greater than that of the second hole 122.

A helium (He) gas may be used as a cooling gas. A supply pipe 170 for supplying the cooling gas is connected to a lower face of the body 110. A main hole 114 is upwardly extended from the lower face of the body 110.

A plurality of inner channels 116 are formed radiating from an upper end portion of the main hole 114 to positions located at predetermined distance from and along an outer peripheral edge portion of the electrostatic chuck. Each of the plurality of first holes 112 is disposed at an end portion of a corresponding one of a plurality of inner channels 116. In addition, each of the plurality of first holes 112 extend from the end portion of its correspond inner channel 116 to an upper face of the body 110.

Referring to FIG. 2, a stepped portion 112a is formed at an upper portion of the first hole 112. The block 120 having a disk shape is inserted into the stepped portion 112a. The stepped portion 112a has a diameter that is greater than that of the first hole 112. The second hole 122 is formed vertically through a central portion of the block 120. It is preferable that the upper face of the body 110 and the upper face of the block 120 are on a substantially same plane. When the block 120 is tightly inserted into the stepped portion 112a, it is preferable that the block 120 does not damage the second insulation layer (not shown) formed on an inner face of the first hole 112.

A plurality of grooves may be formed on an upper portion of the dielectric layer 130. The grooves are connected between the third holes 132. The grooves may be used as a flow path for the cooling gas between the substrate 10 and the dielectric layer 130.

FIG. 3 is a schematic cross-sectional view showing a processing apparatus using plasma having the electrostatic chuck shown in FIG. 1.

Referring to FIG. 3, the processing apparatus 20 using plasma includes a processing chamber 22 for processing a substrate 10, an electrostatic chuck 100 disposed in the chamber 22 for supporting the substrate 10 and upper electrode 26 for generating the plasma using a reaction gas introduced into the chamber 22.

A supply pipe 28 for supplying a reaction gas is connected to a sidewall of the processing chamber 22. A vacuum pump 30 and an exhaust valve 32 are connected to a bottom portion of the processing chamber 22 to exhaust by-products and plasma gases generated during processing of the substrate 10.

RF power is applied to the upper electrode 26 or a body 110 of the electrostatic chuck 100. The RF power generates a plasma gas using the reaction gas introduced into the processing chamber 22 through the supply pipe 28. The plasma gas is used for forming a layer on the substrate 10 or etching a layer formed on the substrate 10.

In case that RF power is applied to the upper electrode 26, bias RF power is applied to the body 110 of the electrostatic chuck 100. Alternatively, in case that RF power is applied to the body 110 of the electrostatic chuck 100, the upper electrode 26 may be used as a ground.

Ceramic blocks 120 disposed at an upper portion of first holes 112 of the electrostatic chuck 100 may minimize the generation of an arc or a glow discharge inside of the first holes 112.

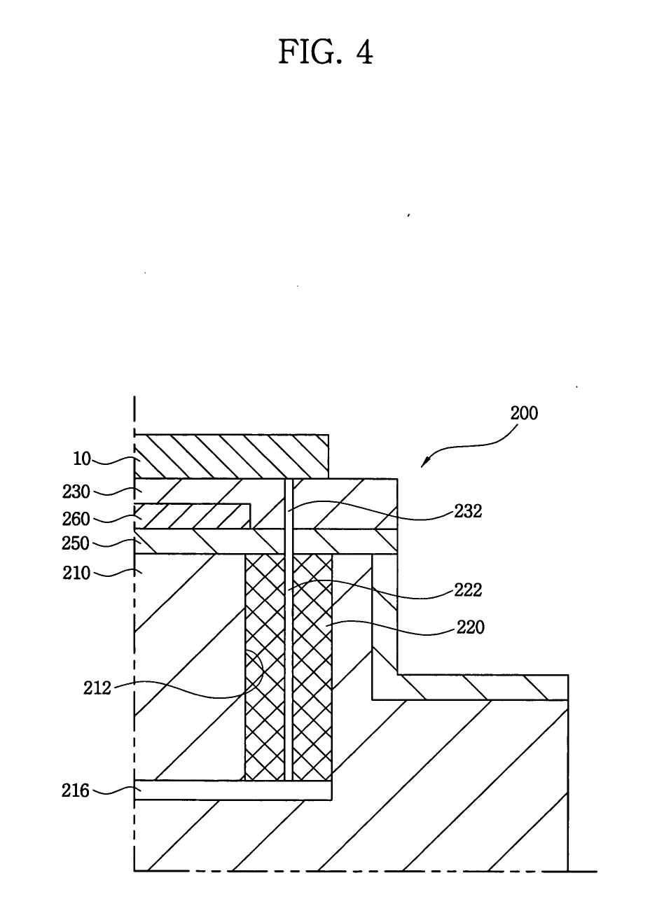

FIG. 4 is an enlarged cross-sectional view showing a ceramic block of an electrostatic chuck according to another embodiment of the present invention.

Referring to FIG. 4, an electrostatic chuck 200 according to another exemplary embodiment of the present invention includes a body 210, a first insulation layer 250, an inner electrode 260 and a dielectric layer 230.

Preferably, the body 210 includes aluminum (Al). The first insulation. layer 250 is formed on an upper face and an outer side face of the body 210 The inner electrode 260 is formed on the first insulation layer 250. The dielectric layer 230 is formed on the inner electrode 260 and the first insulation layer 250.

A plurality of first holes 212 are downwardly extended from the upper face of the body 210. Each of a plurality of ceramic blocks 220 having a cylindrical shape is tightly inserted into a corresponding one of the first holes 212. The ceramic block 220 includes a second hole 222 having a central axis that is substantially identical to that of the first hole 212.

Although it is not particularly shown in the drawing, each of the first holes 212 is connected to a corresponding one of a plurality of inner channels 216 horizontally formed inside of the body 210. The plurality of inner channels 216 are connected to a main hole. The main hole is upwardly extended from a lower face of the body 210. The inner channels 216 extend in a radial direction from an upper end portion of the main hole toward an outer peripheral portion of the body 210. A cooling gas is provided to a backside of the substrate 10 via a supply pipe, or a gas cooling supply pipe. More specifically, the cooling gas is provided to a backside of a substrate 10, which is fixed on a dielectric layer 230 by the electrostatic force, through the main hole, the inner channels 216 and the second holes 222 formed inside the ceramic blocks 220.

Third holes 232 connected to the second holes 222 are formed vertically through the first insulation layer 250 and the dielectric layer 230. It is preferable that the first holes 212, the second holes 222 and third holes 232 have a substantially same central axis. It is also preferable that a diameter of the second holes 222 is substantially equal to that of the third holes 232.

The above-described elements of the electrostatic chuck are substantially similar to the elements explained in detail with reference to FIG. 1. Therefore, any further detailed explanation of the above-described elements is omitted.

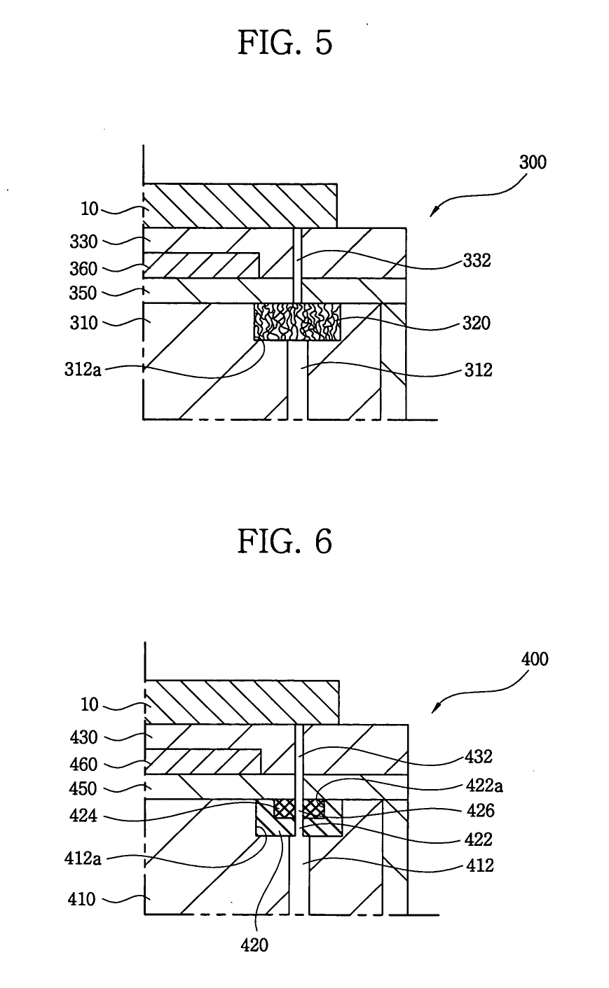

FIG. 5 is an enlarged cross-sectional view showing a ceramic block of an electrostatic chuck according to still another exemplary embodiment of the present invention.

Referring to FIG. 5, the electrostatic chuck 300 includes a body 310, a first insulation layer 350, an inner electrode 360 and a dielectric layer 330.

Preferably, the body 310 includes aluminum (Al). The first insulation layer 350 is formed on an upper face and an outer side face of the body 310. The inner electrode 360 is formed on the first insulation layer 350. The dielectric layer 330 is formed on the inner electrode 360 and the first insulation layer 350.

A plurality of first holes 312 provide a cooling gas to a backside of a substrate 10, which is fixed on the electrostatic chuck 300 by the electrostatic force. The first holes 312 are downwardly extended from the upper face of the body 310. Although it is not particularly shown in the drawing, a supply pipe for supplying the cooling gas, or cooling gas supply pipe, is connected to a bottom face of the body 310. A main hole connected to the cooling gas supply pipe is upwardly extended from a lower face of the body 310. Each of a plurality of inner channels extended in a radial direction from an upper end portion of the main hole toward an outer peripheral portion of the body 310 and is connected to a corresponding one of the first holes 312.

A stepped portion 312a having a diameter that is greater than that of the first hole 312 is formed at an upper portion of the first hole 312. A block 320 including porous ceramic and having a disk shape is tightly inserted into the stepped portion 312a. Preferably, a porosity of the porous ceramic block 320 is preferred about 30% to about 60%, more preferably about 40%. It is preferable that a central axis of the stepped portion is substantially identical to that of the first hole 312.

The dielectric layer 330 is formed on the upper faces of the inner electrode 360 and the first insulation layer 350. A plurality of second holes 322 connected to the first holes 312 is formed vertically through the dielectric layer 330 and the first insulation layer 350.

The cooling gas is provided to the backside of the substrate through the first holes 312, the porous ceramic blocks 320 and the second holes 332. Since an inner face of the first holes 312 is covered with the porous ceramic block 320, the generation of an arc or a glow discharge inside the first holes 312 may be minimized.

The above-described elements of the electrostatic chuck are substantially similar to the elements explained in detail with reference to FIG. 1. Therefore, any further detailed explanation of the above-described elements is omitted.

FIG. 6 is an enlarged cross-sectional view showing an electrostatic chuck according to still another exemplary embodiment of the present invention.

Referring to FIG. 6, the electrostatic chuck 400 according to another exemplary embodiment of the present invention includes a body 410, a first insulation layer 450, an inner electrode 460 and a dielectric layer 430.

Preferably, the body 410 includes aluminum (Al). The first insulation layer 450 is formed on an upper face and an outer side face of the body 410. The inner electrode 460 is formed on the first insulation layer 450. The dielectric layer 430 is formed on the inner electrode 460 and the first insulation layer 450.

A plurality of first holes 412 is downwardly extended from the upper face of the body 410. First blocks 420 are tightly inserted into a stepped portion 412a disposed at an upper portion of the first holes 412. The first block 420 may include aluminum (Al). A second hole 422 having a diameter that is less than that of the first hole 412 is formed vertically along a central axis of the first block 420.

The first stepped portion 412a has a diameter that is greater than that of the first hole 412. A second stepped portion 422a having a diameter that is greater than that of the second hole 422 is formed at an upper portion of the second hole 422.

The first block 420 is inserted into the first stepped portion 412a. A second block 424 is tightly inserted into the second stepped portion 422a. The second block 424 includes ceramic and has a third hole 426 connected to the second hole 422. Although it is not particularly shown in the drawing, a second insulation layer (not shown) is formed on the inner face of the first hole 412. The second hole 422 may be formed, for example, using an anodizing process.

Fourth holes 432 are connected to the first holes 412, the second holes 422 and the third holes 426. The fourth holes 432 are formed vertically through the dialectical layer 430 and the first insulation layer 450. It is preferable that the first holes 412, second holes 422, third holes 426 and fourth holes 432 have a substantially same central axis. It is also preferable that the second holes 422, third holes 426 and fourth holes 432 have a substantially same diameter.

The above-described elements of the electrostatic chuck are substantially similar to the elements explained in detail with reference to FIG. 1. Therefore, any further detailed explanation of the above-described elements is omitted.

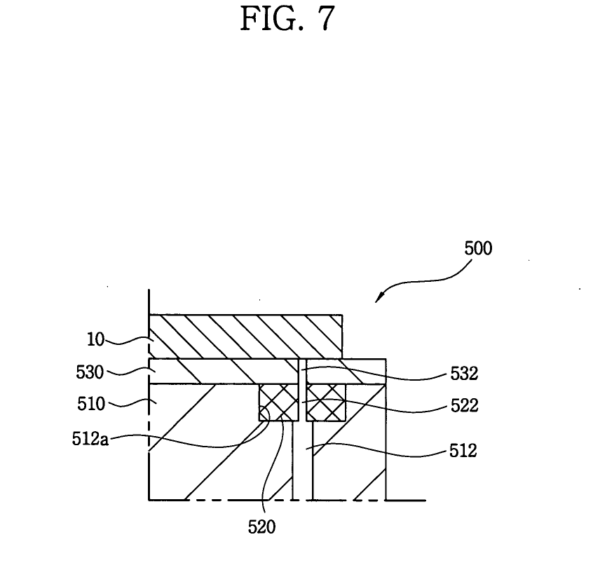

FIG. 7 is an enlarged cross-sectional view showing an electrostatic chuck according to still another exemplary embodiment of the present invention.

Referring to FIG. 7, the electrostatic chuck 500 includes a body 510 and a dielectric layer 530.

The body 510 may include aluminum (Al). The dielectric layer 530 is formed on an upper face of the body 510. The dielectric layer 530 includes ceramic. The dielectric layer 530 may be formed using a plasma spray coating method. RF power or bias power is applied to the body 510. DC power is applied to generate electrostatic force for fixing the semiconductor substrate 10 on the dielectric layer 530.

A plurality of first holes 512 is downwardly extended from an upper face of the body 510. A stepped portion 512a having a diameter that is greater than that of the first hole 512 is formed at the upper portion of the first hole 512. A ceramic block 520 is tightly inserted into the stepped portion 512a. For example, the porous ceramic block shown in FIG. 5 may be tightly inserted into the stepped portion 512a. The ceramic block 520 has a second hole 522 connected to the first hole 512.

Third holes 532 connected to the first holes 512 and the second holes 522 are formed vertically through the dielectric layer 530. It is preferable that the first holes 512, second holes 522 and third holes 532 have a substantially same central axis. It is also preferable that the second holes 522 and third holes 532 have a substantially same diameter.

The above-described elements of the electrostatic chuck are substantially similar to the elements explained in detail with reference to FIG. 1. Therefore, any further detailed explanation of the above-described elements is omitted.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

1. An electrostatic chuck comprising:
a body having a first hole for providing a cooling gas to a backside of a substrate to control a temperature of the substrate;
a block inserted into the first hole, the block comprising ceramic and having a second hole connected to the first hole; and
a dielectric layer being disposed on upper faces of the body and the block and having a third hole connected to the first hole and the second hole.

2. The electrostatic chuck of claim 1, wherein the upper face of the body and the upper face of the block are substantially on a same plane.

3. The electrostatic chuck of claim 1, wherein the block has a disk shape and the block is tightly inserted into the first hole.

4. The electrostatic chuck of claim 3, wherein the first hole has a stepped portion having a diameter that is greater than that of the first hole at an upper portion of the first hole and the block is inserted into the stepped portion.

5. The electrostatic chuck of claim 1, wherein the block has a cylindrical shape and the block is tightly inserted into the first hole.

6. The electrostatic chuck of claim 1, wherein the first hole has a diameter that is greater than that of the second hole.

7. The electrostatic chuck of claim 1, wherein the second hole has a diameter that is substantially equal to that of the third hole.

8. The electrostatic chuck of claim 1, further comprising:
an insulation layer disposed between the dielectric layer and the body; and
an inner electrode disposed between the dielectric layer and the insulation layer for generating an electrostatic force.

9. The electrostatic chuck of claim 1, wherein the body comprises aluminum (Al) and the first hole has an anodized inner face.

10. An electrostatic chuck comprising:
a body having a first hole for providing a cooling gas to a backside of a substrate to control a temperature of the substrate;
a block being inserted into the first hole and comprising porous ceramic; and
a dielectric layer fixing the substrate thereon, being disposed on upper faces of the body and the block and comprising a second hole having a central axis that is substantially identical to that of the first hole.

11. The electrostatic chuck of claim 10, wherein the block has a disk shape and the block is tightly inserted into the first holes.

12. The electrostatic chuck of claim 11, wherein the first hole has a stepped portion having a diameter that is greater than that of the first hole at an upper portion of the first hole and the block is inserted into the stepped portion.

13. The electrostatic chuck of claim 10, further comprising:
an insulation layer disposed between the dielectric layer and the body; and
an inner electrode disposed between the dielectric layer and the insulation layer for generating electrostatic force.

14. The electrostatic chuck as claimed in claim 10, wherein the body comprises aluminum (Al) and wherein the first hole has an anodized inner face.

15. An electrostatic chuck comprising:
a body having a first hole for providing a cooling gas to a backside of a substrate to control a temperature of the substrate;
a first block being inserted into the first hole and having a second hole connected to the first hole;
a second block, inserted into the second hole, comprising ceramic and having a third hole connected to the second hole; and
a dielectric layer fixing the substrate thereon, being disposed on upper faces of the first block and the second block and having a fourth hole connected to the first, second and third holes.

16. The electrode chuck as of claim 15, wherein the first hole has a first stepped portion at an upper portion of the first hole, the second hole has a second stepped portion at an upper portion of the second hole and the first block and the second block are inserted into the first stepped portion and the second stepped portion, respectively.
